(19) United States
(12) Patent Application Publication
(10) Pub. No.: US 2025/0104931 A1
(43) Pub. Date: Mar. 27, 2025

(54) ELECTROLYTIC CAPACITOR

(71) Applicant: Panasonic Intellectual Property Management Co., Ltd., Osaka (JP)

(72) Inventors: YUJI MIYACHI, Saga (JP); TOMOAKI KIDA, Saga (JP); TSUYOSHI KUSAKABE, Fukuoka (JP); MASANORI KASHIHARA, Saga (JP)

(21) Appl. No.: 18/826,775

(22) Filed: Sep. 6, 2024

(30) Foreign Application Priority Data
Sep. 27, 2023 (JP) 2023-166014

(51) Int. Cl. H01G 9/08; H01G 9/15

(52) U.S. Cl. CPC H01G 9/08; H01G 9/15

(57) ABSTRACT

An electrolytic capacitor includes a capacitor element including an anode part and a cathode part, an anode lead frame electrically connected to the anode part, a cathode lead frame electrically connected to the cathode part, and an outer package covering the capacitor element. The anode lead frame includes an anode buried part buried in the outer package. The cathode lead frame includes a cathode buried part buried in the outer package. A first surface of at least one of the anode buried part or cathode buried part includes a plurality of recesses. A protrusions is provided at an outer edge of each of the plurality of recesses.

### BACKGROUND

### 1. Technical Field

The present disclosure relates to an electrolytic capacitor.

### 2. Description of the Related Art

In related art, an electrolytic capacitor which is a capacitor using a metal oxide film as a dielectric has been known (for example, WO 2023/008185 A). The electrolytic capacitor of WO 2023/008185 A includes a capacitor element having an anode part and a cathode part, an anode lead frame electrically connected to the anode part, a cathode lead frame electrically connected to the cathode part, and an outer package covering the capacitor element. The anode lead frame has a first buried part buried in the outer package, the cathode lead frame has a second buried part buried in the outer package, and a plurality of recesses are formed on a surface of at least one of the first buried part and the second buried part.

### SUMMARY

An aspect of the present disclosure relates to an electrolytic capacitor. The electrolytic capacitor includes a capacitor element including an anode part and a cathode part, an anode lead frame electrically connected to the anode part, a cathode lead frame electrically connected to the cathode part, and an outer package covering the capacitor element. The anode lead frame includes an anode buried part buried in the outer package, and the cathode lead frame includes a cathode buried part buried in the outer package. A first surface of at least one of the anode buried part and the cathode buried part includes a plurality of recesses. A protrusion is provided at an outer edge of each of the plurality of recesses.

According to the present disclosure, an increase in equivalent series resistance (ESR) can be suppressed.

### BRIEF DESCRIPTION OF THE DRAWINGS

FIG. 1 is a sectional view schematically illustrating an example of an electrolytic capacitor according to the present disclosure;

FIG. 2 is a top view schematically illustrating an example of disposition of recesses and protrusions in each lead frame; and

FIG. 3 is a sectional view schematically illustrating a section taken along line III-III in FIG. 2.

### DETAILED DESCRIPTIONS OF EMBODIMENTS

Hereinafter, problems of the prior art will be briefly described. When the electrolytic capacitor is used, oxygen or moisture may reach the capacitor element through an interface between the outer package and each lead frame. When the oxygen or moisture reaches the capacitor element, an electrolyte deteriorates, and equivalent series resistance (ESR) of the electrolytic capacitor increases.

The present disclosure provides an electrolytic capacitor capable of suppressing an increase in ESR.

Hereinafter, an exemplary embodiment of an electrolytic capacitor according to the present disclosure will be described in conjunction with examples. However, the present disclosure is not limited to the examples to be described below. Although specific numerical values and materials may be provided as some examples in the following description, other numerical values and materials may be used as long as the effect of the present disclosure can be achieved.

An electrolytic capacitor according to the present disclosure includes a capacitor element, an anode lead frame, a cathode lead frame, and an outer package. In the following description, the anode lead frame and the cathode lead frame may be referred to as lead frames without distinction.

The capacitor element includes an anode part and a cathode part. The anode part may be an anode body or may include an anode body and an anode wire. The anode body may be a porous sintered body or a metal foil having a porous surface. A dielectric layer may be formed on a surface of the anode body. The cathode part may include an electrolyte layer (solid electrolyte layer) and a cathode layer. The electrolyte layer is disposed between the dielectric layer formed on the surface of the anode body and the cathode layer. These constituent elements are not particularly limited, and constituent elements used for known electrolytic capacitors may be applied. Examples of these constituent elements will be described below.

The anode body may be formed by sintering material particles. Examples of the material particles include particles of a valve metal, particles of an alloy containing a valve metal, and particles of a compound containing a valve metal. One of these kinds of particles may be used alone, or two or more of these kinds may be used in mixture. Alternatively, a valve metal foil may be used as the anode body. Examples of the valve metal include titanium (Ti), tantalum (Ta), niobium (Nb), and aluminum (Al). A preferred example of the anode body as a sintered body is a sintered body of tantalum. A preferred example of the anode body as a metal foil is an aluminum foil.

The dielectric layer formed on the surface of the anode body is not particularly limited, and it may be formed by a known method. For example, the dielectric layer may be formed by anodizing the surface of the anode body.

As the anode wire, a wire made of metal can be used. Examples of the material of the anode wire include the above-described valve metals, copper, and aluminum alloy. The anode wire is partially buried in the anode body, and the remaining part protrudes from an end surface of the anode body.

The electrolyte layer (solid electrolyte layer) is not particularly limited, and the solid electrolyte layer used in a known electrolytic capacitor may be applied. The electrolyte layer is disposed to cover at least a part of the dielectric layer. The electrolyte layer may be formed using a manganese compound or a conductive polymer. Examples of the conductive polymer include polypyrrole, polythiophene, polyaniline, and derivatives thereof these polymers. These polymers may be used alone or in combination of a plurality of polymers. In addition, the conductive polymer may be a copolymer of two or more monomers. The derivative of the conductive polymer means a polymer having the conductive polymer as a basic skeleton. For example, examples of the derivative of the polythiophene include poly (3,4-ethylenedioxythiophenc).

A dopant is preferably added to the conductive polymer. The dopant can be selected in accordance with the conductive polymer, and a known dopant (for example, a polymer dopant) may be used. Examples of the dopant include naphthalenesulfonic acid, p-toluenesulfonic acid, polystyrenesulfonic acid, and salts of these dopants. An example of the electrolyte layer is formed using poly (3,4-ethylenedioxythiophene) (PEDOT) doped with polystyrenesulfonic acid (PSS).

The electrolyte layer containing the conductive polymer may be formed by polymerizing a monomer as a raw material on the dielectric layer. Alternatively, the electrolyte layer containing the conductive polymer may be formed by disposing a liquid containing the conductive polymer (and a dopant as necessary) on the dielectric layer and then drying the liquid.

The cathode layer is a layer having conductivity and is disposed to cover at least a part of the electrolyte layer. The cathode layer includes a cathode lead-out layer having conductivity. The cathode layer may include another conductive layer (for example, a carbon layer) disposed between the electrolyte layer and the cathode lead-out layer. For example, the cathode layer may include a carbon layer formed on the electrolyte layer and a cathode lead-out layer formed on the carbon layer. The cathode lead-out layer may be made of a metal paste (for example, a silver paste) containing metal particles (for example, silver particles) and a resin, or may be made of a known silver paste. The carbon layer is a layer containing carbon, and may be made of a resin and a conductive carbon material such as graphite.

The anode lead frame is electrically connected to the anode part. The anode lead frame may have a base material made of metal (copper, copper alloy, or the like). A thickness of the base material is not particularly limited, and may range from 25 μm to 200 μm, inclusive (for example, ranging from 25 μm to 100 μm, inclusive). The anode lead frame may include a base material and a plating layer formed on the base material.

The plating layer is formed of a metal (including an alloy) such as nickel, gold, palladium, tin, or copper, and may include a nickel layer, a gold layer, a palladium layer, a tin layer, a copper layer, or the like. For example, the plating layer may be stacked on the base material in the order of a nickel layer, a gold layer, and a palladium layer. The plating layer can be formed by a known plating method. The plating layer may be formed before a recess and a protrusion to be described later are formed, or may be formed after the recess and the protrusion are formed.

The cathode lead frame is electrically connected to the cathode part. The cathode lead frame may have a base material made of metal (copper, copper alloy, or the like). A thickness of the base material is not particularly limited, and may range from 25 μm to 200 μm, inclusive (for example, ranging from 25 μm to 100 μm, inclusive). The cathode lead frame may include a base material and a plating layer formed on the base material. The plating layer of the cathode lead frame may be similar to the plating layer described above in connection with the anode lead frame.

The outer package covers the capacitor element. The outer package may be disposed around the capacitor element such that the capacitor element is not exposed on a surface of the electrolytic capacitor. Further, the outer package may be disposed to cover an anode buried part and a cathode buried part to be described later. The outer package usually contains a resin (insulating resin) and an insulating filler. In the following description, the anode buried part and the cathode buried part may be referred to as buried parts without distinction.

The outer package can be made of a resin composition including an insulating resin and an insulating filler (for example, an inorganic filler). The resin composition may include a curing agent, a polymerization initiator, a catalyst, and the like in addition to the insulating resin and the insulating filler. Examples of the insulating resin include an insulating thermosetting resin and an insulating thermoplastic resin. Specific examples of the insulating resin include epoxy resin, phenol resin, urea resin, polyimide, polyamide-imide, polyurethane, diallyl phthalate, unsaturated polyester, polyphenylene sulfide (PPS), and polybutylene terephthalate (PBT).

Examples of the insulating filler include insulating particles and insulating fibers. Examples of the insulating material forming the insulating filler include insulating compounds (for example, oxides) such as silica and alumina, glass, and mineral materials (for example, talc, mica, or clay). The insulating filler contained in the outer package may be one type or two or more types.

The anode lead frame has an anode buried part buried in the outer package. The anode buried part of the anode lead frame may be electrically connected to the anode part of the capacitor element by, for example, welding. The anode lead frame may further include an anode exposed part exposed from the outer package. At least a part of the anode exposed part can function as an anode external terminal.

The cathode lead frame has a cathode buried part buried in the outer package. The cathode buried part of the cathode lead frame may be electrically connected to the cathode part of the capacitor element via, for example, an electrically conductive adhesive layer. The electrically conductive adhesive layer may include conductive particles (for example, metal particles such as silver particles). The electrically conductive adhesive layer can be formed by using a metal paste (for example, a silver paste) containing metal particles and a resin. The cathode lead frame may further include a cathode exposed part exposed from the outer package. At least a part of the cathode exposed part can function as a cathode external terminal.

A surface (first surface) of at least one of the anode buried part or the cathode buried part includes a plurality of recesses. And a protrusion is provided at an edge of each of the plurality of recesses. The surface of at least one of the anode buried part and the cathode buried part may be a principal surface of at least one of the anode buried part and the cathode buried part. The recesses and the protrusions may be formed by irradiating each buried part with a laser beam. The recesses and the protrusions may be formed on both principal surfaces of each buried part, or may be formed only on one principal surface of each buried part. By providing the recesses and the protrusions, a surface area of the anode buried part and/or the cathode buried part is increased. Thus, adhesiveness is improved by an anchor effect between the outer package and the anode buried part and/or the cathode buried part. Hence, since oxygen and moisture hardly reach the capacitor element through an interface between each lead frame and the outer package, deterioration of the electrolyte layer can be suppressed, and an increase in ESR of the electrolytic capacitor can be suppressed.

The protrusion may be formed in an annular shape along the outer edge of the recess. By providing an annular protrusion, the anchor effect can be improved by increasing the surface area of the anode buried part and/or the cathode buried part. Thus, the increase in ESR of the electrolytic capacitor can be further suppressed. The protrusion may be intermittently formed along the outer peripheral edge of the recess.

In recesses (a first recess and a second recess) adjacent to each other along the surface of the anode buried part and/or the cathode buried part in which the recess and the protrusion are formed, the protrusion positioned at the outer edge of the first recess and the protrusion positioned at the outer edge of the second recess may be separated from each other. In this configuration, a region where the surface of the anode buried part and/or the cathode buried part is exposed is interposed between the adjacent protrusions. As compared with a case where the adjacent protrusions are connected to each other, the surface area of each buried part can be increased, and the reduction in ESR of the electrolytic capacitor can be further suppressed.

A depth of the recess may range from 10 μm to 55 μm, inclusive. By setting the depth of the recess within this range, adhesiveness between each lead frame and the outer package or the adhesive can be improved. The depth of the recess refers to a distance in a depth direction between the surface on which the recess is formed and a deepest portion of the recess. The depth of the recess may be obtained as an average of measured values obtained by measuring depths of any selected 10 recesses. The depth of the recess may be measured in a section parallel to a thickness direction of each lead frame.

A height of the protrusion may range from 0.1 μm to 50 μm, inclusive. By setting the height of the protrusion within this range, the adhesiveness between each lead frame and the outer package or the adhesive can be improved. The height of the protrusion refers to a distance in a height direction between the surface on which the protrusion is formed and a top of the protrusion. The height of the protrusion may be obtained as an average of measured values obtained by measuring heights of any selected 10 protrusions. The any selected 10 protrusions may correspond to different recesses. A height of the protrusion may be measured in the section parallel to the thickness direction of each lead frame.

A ratio of the depth of the recess to the height of the protrusion may range from 0.2 to 550, inclusive. By setting the ratio of the depth of the recess to the height of the protrusion within this range, the adhesiveness between each lead frame and the outer package or the adhesive agent can be improved.

As viewed in a direction perpendicular to the surface of the anode buried part and/or the cathode buried part, a ratio of a total area of the plurality of recesses to an area of the surface of each of the buried parts may range from 5% to 25%, inclusive, per unit area. By setting the ratio of the total area of the plurality of recesses to the area of the surface of each of the buried parts within this range, it is possible to improve the adhesiveness between each lead frame and the outer package or the adhesive. The total area of the plurality of recesses per unit area may be obtained based on a load area ratio at an intersection of a load curve corresponding to a definition region of a measurement surface (in this example, the surface of the anode buried part and/or the cathode buried part) and a height of a lower portion of a core portion. The total area of the plurality of recesses per unit area can be obtained by using a laser microscope (for example, VK-X3000 manufactured by KEYENCE CORPORATION).

As viewed in the direction perpendicular to the surface of the anode buried part and/or the cathode buried part, a ratio of a total area of the plurality of protrusions to an area of the surface of each of the buried parts may range from 5% to 30%, inclusive, per unit area. By setting the ratio of the total area of the plurality of protrusions to the area of the surface of each of the buried parts within this range, it is possible to improve the adhesiveness between each lead frame and the outer package or the adhesive. The total area of the plurality of protrusions per unit area may be obtained based on a load area ratio at an intersection of a load curve corresponding to a definition region of a measurement surface (in this example, the surface of the anode buried part and/or the cathode buried part) and a height of a lower portion of a core portion. The total area of the plurality of protrusions per unit area can be obtained using a laser microscope (for example, VK-X3000 manufactured by KEYENCE CORPORATION).

As viewed in the direction perpendicular to the surface of the anode buried part and/or the cathode buried part, a ratio of the total area of the plurality of recesses to the total area of the plurality of protrusions may range from 0.16 to 5, inclusive, per unit area. By setting the ratio of the total area of the plurality of recesses to the total area of the plurality of protrusions within this range, it is possible to improve the adhesiveness between each lead frame and the outer package or the adhesive.

As viewed in the direction perpendicular to the surface of the anode buried part and/or the cathode buried part, an average opening diameter of the recesses may range from 5 μm to 200 μm, inclusive. By setting the average opening diameter of the recesses within this range, it is possible to improve the adhesiveness between each lead frame and the outer package or the adhesive. An equivalent circle diameter can be used as an opening diameter of each recess. The equivalent circle diameter is obtained by the following method. First, an image of the opening of the recess is captured from above. Next, the obtained image is subjected to image processing to obtain the area of the opening. Next, the equivalent circle diameter is calculated from the obtained area. The average opening diameter is obtained by calculating the diameter (equivalent circle diameter) of the opening for each of any selected 10 recesses and arithmetically averaging the obtained diameters.

As described above, according to the present disclosure, the recesses and the protrusions are formed on the surface of the lead frame, and thus, it is possible to suppress the increase in ESR of the electrolytic capacitor.

Hereinafter, an example of the electrolytic capacitor according to the present disclosure will be specifically described with reference to the drawings. The above-described constituent elements can be applied to constituent elements of an electrolytic capacitor as the example to be described below. The constituent elements of the electrolytic capacitor as the example to be described below can be changed based on the above-described description. Matters to be described below may be applied to the above-described exemplary embodiment. Among the constituent elements of the electrolytic capacitor as the example to be described below, constituent elements that are not essential to the electrolytic capacitor according to the present disclosure may be omitted. The following drawings are schematic and do not accurately reflect the shape and number of actual members.

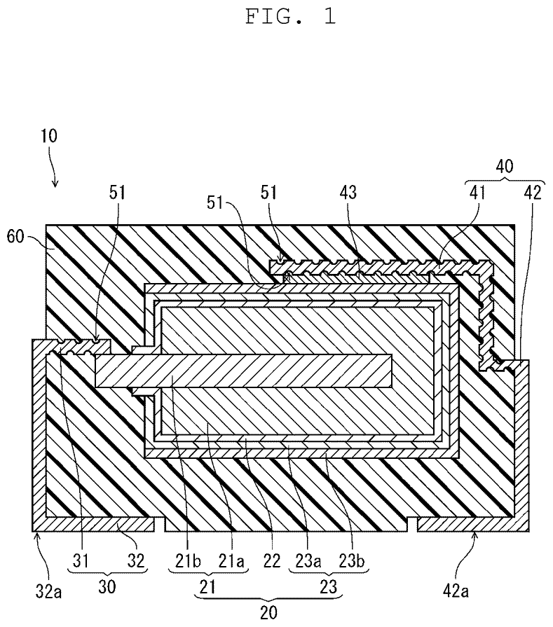

As illustrated in FIGS. 1 to 3, electrolytic capacitor 10 of the present exemplary embodiment includes capacitor element 20, anode lead frame 30, cathode lead frame 40, and outer package 60.

Capacitor element 20 includes anode part 21, dielectric layer 22, and cathode part 23. Anode part 21 includes anode body 21a and anode wire 21b. Anode body 21a is a porous sintered body having a rectangular parallelepiped shape, and dielectric layer 22 is formed on a surface of the porous sintered body (including inner surfaces of pores in the porous sintered body).

A part of anode wire 21b protrudes from one end surface of anode body 21a toward one end surface (left end surface in FIG. 1) of electrolytic capacitor 10. The other part of anode wire 21b is buried in anode body 21a. Anode wire 21b extends along a longitudinal direction of anode body 21a (left-right direction in FIG. 1). Cathode part 23 includes electrolyte layer 23a disposed to cover at least a part of dielectric layer 22, and cathode layer 23b formed to cover at least a part of electrolyte layer 23a.

Anode lead frame 30 is electrically connected to anode part 21. Anode lead frame 30 includes anode buried part 31 buried in outer package 60 and anode exposed part 32 exposed from outer package 60. Anode buried part 31 is electrically connected to anode part 21 by welding. Anode exposed part 32 includes anode terminal 32a that functions as a terminal on the anode side.

Cathode lead frame 40 is electrically connected to cathode part 23. Cathode lead frame 40 includes cathode buried part 41 buried in outer package 60 and cathode exposed part 42 exposed from outer package 60. Cathode buried part 41 is electrically connected to cathode part 23 via electrically conductive adhesive layer 43. Cathode exposed part 42 includes cathode terminal 42a that functions as a terminal on the cathode side.

Outer package 60 covers capacitor element 20, anode buried part 31, and cathode buried part 41. The outer package is disposed around capacitor element 20 such that capacitor element 20 is not exposed on a surface of electrolytic capacitor 10. Outer package 60 includes an insulating resin and an insulating filler.

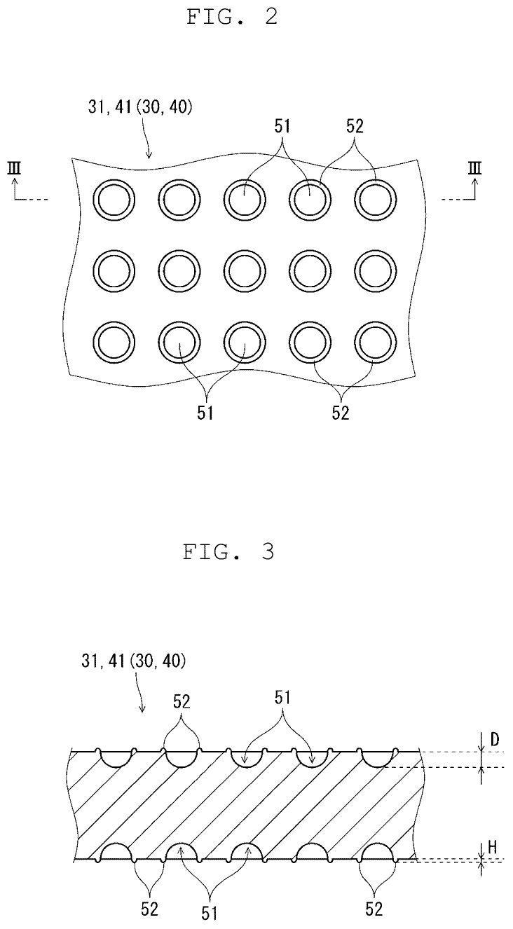

As illustrated in FIGS. 2 and 3, both surfaces (or both principal surfaces) of each of anode lead frame 30 and cathode lead frame 40 include a plurality of recesses 51. And protrusion 52 is provided at the outer edge of the plurality of recesses 51. Protrusion 52 is preferably formed in an annular shape along the outer edge of recess 51. In two recesses 51 (a first recess and a second recess) of the plurality of recesses 51 adjacent to each other along the surface, protrusion 52 positioned at the outer edge of first recess 51 and protrusion 52 positioned at the outer edge of second recess 51 are preferably separated from each other.

Depth D of recess 51 ranges preferably from 2 μm to 55 μm, inclusive, more preferably from 10 μm to 30 μm, inclusive, and particularly preferably from 20 μm to 30 μm, inclusive. Height H of protrusion 52 ranges preferably from 0.1 μm to 1.0 μm, inclusive, and more preferably from 0.5 μm to 1.0 μm, inclusive. A ratio of depth D of recess 51 to height H of protrusion 52 ranges preferably from 0.2 to 550, inclusive, more preferably from 10 times to 300 times, inclusive, and still more preferably from 20 times to 150 times, inclusive.

As viewed in a direction perpendicular to the surface of anode buried part 31 and/or cathode buried part 41, a ratio of a total area of the plurality of recesses 51 to an area of the surface of each of buried parts 31 and 41, per unit area, ranges preferably from 5% to 25%, inclusive, and more preferably from 15% to 25%, inclusive. As viewed in the direction perpendicular to the surface of anode buried part 31 and/or cathode buried part 41, a ratio of a total area of the plurality of protrusions 52 to an area of the surface of each of buried parts 31 and 41, per unit area, ranges preferably from 5% to 30%, inclusive, and more preferably from 5% to 15%, inclusive. As viewed in the direction perpendicular to the surface of anode buried part 31 and/or cathode buried part 41, a ratio of a total area of the plurality of recesses 51 to a total area of the plurality of protrusions 52, per unit area, ranges preferably from 0.16 to 5, inclusive, and more preferably from 1 to 3, inclusive. As viewed in the direction perpendicular to the surface of anode buried part 31 and/or cathode buried part 41, an average opening diameter of recesses 51 ranges preferably from 5 μm to 200 μm, inclusive, and more preferably from 10 μm to 100 μm, inclusive.

### Appendix

The above description of the exemplary embodiment discloses the following technologies.

### (Technology 1)

An electrolytic capacitor including:
a capacitor element including an anode part and a cathode part,
an anode lead frame electrically connected to the anode part,
a cathode lead frame electrically connected to the cathode part, and
an outer package covering the capacitor element,
in which the anode lead frame includes an anode buried part buried in the outer package,
the cathode lead frame includes a cathode buried part buried in the outer package,
a first surface of at least one of the anode buried part or the cathode buried part includes a plurality of recesses, and
a protrusion is provided at an outer edge of each of the plurality of recesses.

### (Technology 2)

The electrolytic capacitor according to Technology 1, in which the protrusion is formed in an annular shape along the outer edge of the each of the plurality of recesses.

### (Technology 3)

The electrolytic capacitor according to Technology 1 or 2, in which, in a first recess and a second recess adjacent to each other along the first surface among the plurality of recesses, the protrusion positioned at the outer edge of the first recess and the protrusion positioned at the outer edge of the second recess are separated from each other.

### (Technology 4)

The electrolytic capacitor according to any one of Technologies 1 to 3, in which a depth of each of the plurality of recesses ranges from 10 μm to 55 μm, inclusive.

### (Technology 5)

The electrolytic capacitor according to any one of Technologies 1 to 4, in which a height of the protrusion ranges from 0.1 μm to 50 μm, inclusive.

### (Technology 6)

The electrolytic capacitor according to any one of Technologies 1 to 5, in which a ratio of a depth of each of the plurality of recesses to a height of the protrusion ranges from 0.2 to 550, inclusive.

### (Technology 7)

The electrolytic capacitor according to any one of Technologies 1 to 6, in which, as viewed in a direction perpendicular to the first surface, a ratio of a total area of the plurality of recesses to an area of the first surface ranges from 5% to 25%, inclusive, per unit area.

### (Technology 8)

The electrolytic capacitor according to any one of Technologies 1 to 7, in which, as viewed in a direction perpendicular to the first surface, a ratio of a total area of a plurality of protrusions including the protrusion to an area of the first surface ranges from 5% to 30%, inclusive, per unit area.

### (Technology 9)

The electrolytic capacitor according to any one of Technologies 1 to 8, in which, as viewed in a direction perpendicular to the first surface, a ratio of a total area of the plurality of recesses to a total area of a plurality of protrusions including the protrusion ranges from 0.16 to 5, inclusive, per unit area.

### (Technology 10)

The electrolytic capacitor according to any one of Technologies 1 to 9, in which, as viewed in a direction perpendicular to the first surface, an average opening diameter of the plurality of recesses ranges from 5 μm to 200 μm, inclusive.

### EXAMPLES

A change ratio of ESR before and after a heat cycle test was measured for electrolytic capacitors of Examples 1 to 3 and Comparative Examples 1 and 2 to be illustrated below. As the heat cycle test, a following test was performed. The electrolytic capacitors were alternately placed in an atmosphere at −55° C. and an atmosphere at 125° C. for 15 minutes, and this alternate placement was repeated about 1,000 cycles. The change ratio of ESR before and after the heat cycle test indicates a ratio of the ESR after the heat cycle test to the ESR before the heat cycle test. For example, when the change ratio is 2, it means that the ESR after the heat cycle test is doubled with respect to the ESR before the heat cycle test.

### Example 1

The electrolytic capacitor corresponding to the above exemplary embodiment was prepared. The recesses and the protrusions were formed by irradiating the surface of each lead frame with a laser beam. The depth of the recess was 27.5 μm, and the height of the protrusion was 0.69 μm. The ratio of the total area of the plurality of recesses to the area of the surface of each lead frame per unit area was 20.7%, and the ratio of the total area of the plurality of protrusions to the area of the surface of each lead frame was 9.9%. The change ratio of ESR before and after the heat cycle test was 1.2.

### Example 2

The electrolytic capacitor corresponding to the above exemplary embodiment was prepared. The recesses and the protrusions were formed by irradiating the surface of each lead frame with a laser beam. The depth of the recess was 40.9 μm, and the height of the protrusion was 5.45 μm. The ratio of the total area of the plurality of recesses to the area of the surface of each lead frame per unit area was 7.6%, and the ratio of the total area of the plurality of protrusions to the area of the surface of each lead frame was 25.3%. The change ratio of ESR before and after the heat cycle test was 1.5.

### Example 3

The electrolytic capacitor corresponding to the above exemplary embodiment was prepared. The recesses and the protrusions were formed by irradiating the surface of each lead frame with a laser beam. The depth of the recess was 28.9 μm, and the height of the protrusion was 2.66 μm. The ratio of the total area of the plurality of recesses to the area of the surface of each lead frame per unit area was 15.6%, and the ratio of the total area of the plurality of protrusions to the area of the surface of each lead frame was 16.7%. The change ratio of ESR before and after the heat cycle test was 1.3.

### Comparative Example 1

An electrolytic capacitor having recesses but no protrusions in each lead frame was prepared. The recesses were formed by cutting the surface of each lead frame. The depth of the recess was 27.5 μm. The ratio of the total area of the plurality of recesses to the area of the surface of each lead frame per unit area was 20.7%. The change ratio of ESR before and after the heat cycle test was 5.

### Comparative Example 2

An electrolytic capacitor having neither recesses nor protrusions on each lead frame was prepared. The change ratio of ESR before and after the heat cycle test was 10.

As described above, the electrolytic capacitors of Examples 1 to 3 had a lower change ratio of ESR before and after the heat cycle test than the electrolytic capacitors of Comparative Examples 1 and 2. Therefore, it can be said that superiority of each example was illustrated.

The present disclosure can be used for an electrolytic capacitor.

What is claimed is:

1. An electrolytic capacitor comprising:
a capacitor element including an anode part and a cathode part;
an anode lead frame electrically connected to the anode part;
a cathode lead frame electrically connected to the cathode part; and
an outer package covering the capacitor element, wherein:
the anode lead frame includes an anode buried part buried in the outer package,
the cathode lead frame includes a cathode buried part buried in the outer package,
a first surface of at least one of the anode buried part or the cathode buried part includes a plurality of recesses, and
a protrusion is provided at an outer edge of each of the plurality of recesses.

2. The electrolytic capacitor according to claim 1, wherein the protrusion is formed in an annular shape along the outer edge of the each of the plurality of recesses.

3. The electrolytic capacitor according to claim 1, wherein, in a first recess and a second recess adjacent to each other along the first surface among the plurality of recesses, the protrusion positioned at the outer edge of the first recess and the protrusion positioned at the outer edge of the second recess are separated from each other.

4. The electrolytic capacitor according to claim 1, wherein a depth of each of the plurality of recesses ranges from 10 μm to 55 μm, inclusive.

5. The electrolytic capacitor according to claim 1, wherein a height of the protrusion ranges from 0.1 μm to 50 μm, inclusive.

6. The electrolytic capacitor according to claim 1, wherein a ratio of a depth of each of the plurality of recesses to a height of the protrusion ranges from 0.2 to 550, inclusive.

7. The electrolytic capacitor according to claim 1, wherein, as viewed in a direction perpendicular to the first surface, a ratio of a total area of the plurality of recesses to an area of the first surface ranges from 5% to 25%, inclusive, per unit area.

8. The electrolytic capacitor according to claim 1, wherein, as viewed in a direction perpendicular to the first surface, a ratio of a total area of a plurality of protrusions including the protrusion to an area of the first surface ranges from 5% to 30%, inclusive, per unit area.

9. The electrolytic capacitor according to claim 1, wherein, as viewed in a direction perpendicular to the first surface, a ratio of a total area of the plurality of recesses to a total area of a plurality of protrusions including the protrusion ranges from 0.16 to 5, inclusive, per unit area.

10. The electrolytic capacitor according to claim 1, wherein, as viewed in a direction perpendicular to the first surface, an average opening diameter of the plurality of recesses ranges from 5 μm to 200 μm, inclusive.
